(19) United States
(12) Patent Application Publication
(10) Pub. No.: US 2025/0225596 A1
(43) Pub. Date: Jul. 10, 2025

(54) METHOD AND SYSTEM FOR DETERMINING THE PROOF OF POWER ORIGIN FOR PRODUCTION UNITS PRODUCED BY A POWER CONSUMING DEVICE

(71) Applicant: Timothy F. CONDON, Park Ridge, IL (US)

(72) Inventor: Timothy F. CONDON, Park Ridge, IL (US)

(21) Appl. No.: 19/091,022

(22) Filed: Mar. 26, 2025

Related U.S. Application Data
(63) Continuation-in-part of application No. PCT/US2023/075086, filed on Sep. 26, 2023.
(60) Provisional application No. 63/410,036, filed on Sep. 26, 2022.

(51) Int. Cl. G06Q 50/06; G01R 22/06; G06F 21/64; G06Q 30/018; H02J 3/38; H04L 9/00

(52) U.S. Cl. CPC G06Q 50/06; G01R 22/061; G06F 21/64; G06Q 30/018; H02J 3/381; H04L 9/50; H02J 2203/10; H02J 2300/24

(57) ABSTRACT

A system for verifiably determining carbon emissions associated with a creation of a unit of production is disclosed.

### BACKGROUND INFORMATION

While societies in developed nations are growing more and more aware of the impact humans are having on the environment, there are still many activities that persist that are emitting carbon dioxide (CO2) or equivalents into our shared atmosphere. Despite calls for emission reduction, certain activities continue (e.g., manufacturing of virgin plastic components) and are even accelerating (e.g., mining for cryptocurrencies). While consumer behaviors are becoming more aligned with emission reductions, they are calling for reduced carbon footprints in the products they buy. The resulting environment creates opportunities for producers of products to disclose the carbon footprints of their products to make their products more attractive to consumers. The validity of the disclosed carbon footprints is problematic and requires a methodology to make the process transparent to product consumers in their primary and secondary markets. Any producer who employed this method and system in their production environment will be prevented from disclosing low carbon units of production while actually utilizing higher carbon energy to produce their units of products. Such a methodology would provide consumers, and potentially regulators, or other authorities, to have confidence that the carbon footprint of the products they are consuming are accurate and that any decisions they make to opt for one product versus another based on carbon footprint disclosures under such a methodology will have a positive effect on our shared environment. When employed, this system may help prevent manufacturers or producers of carbon free goods from promoting they are producing more carbon free goods than they actually have carbon free energy to produce.

### BRIEF DESCRIPTION OF THE DRAWINGS

In order to facilitate a fuller understanding of the exemplary embodiments, reference is now made to the appended drawings. These drawings should not be construed as limiting but are intended to be exemplary only.

FIG. 1 is a block diagram of system that will enable the determination of the origin of the power provided to a system if the system is found to be in balance per the methods described in FIG. 2., in accordance with an exemplary embodiment.

FIG. 2 depicts a method for determining if the power sources and the uses of power consumed by all and each Power Consuming Device (PCD) in a system are sufficiently balanced to determine that there is no leakage into or out of a system, in accordance with an exemplary embodiment.

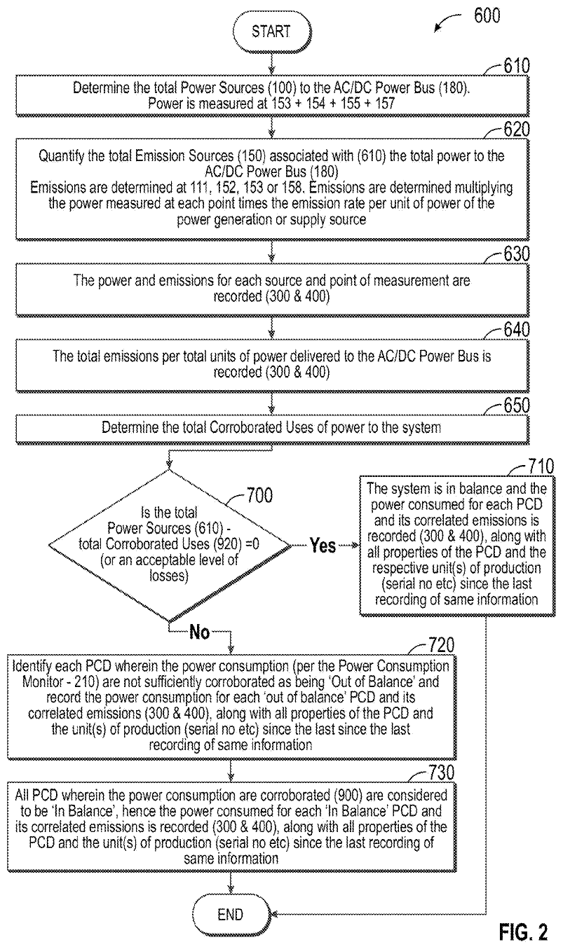

FIG. 3 depicts a method for determining if the power consumption, as measured at the point of consumption, is corroborated by a plurality of corroborating metrics, including virtual meters, environmental sensors, consumption rates inferred from external information or data, or other sources of metrics.

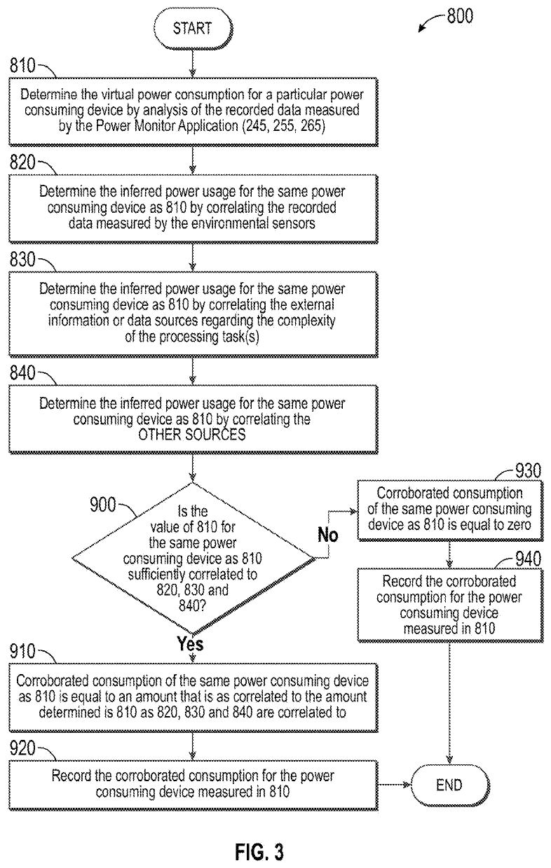

### DETAILED DESCRIPTION OF THE PREFERRED EMBODIMENTS

An exemplary embodiment provides a system and method for measuring the sources of power into a production environment, tracking the carbon emission composition of each and all the power sources into the production environment while disclosing both the power sourced into and the related emissions to a database, and then measuring each and all of the actual power consumption of the same production environment in multiple ways so as to confirm that there is no other power being consumed in the production environment than is being disclosed. By utilizing this sources v. uses power accounting approach to account for all energy in a production environment, the system and method can determine if there is other power being consumed within the production environment (leakage), which could be of a different (likely higher) carbon emission content than what is being disclosed. By utilizing this system and method to keep the accounting for sources and uses balanced within a production environment, the consumer of a product produced by the production environment can have transparency as to the carbon emission content of a product that they purchase or consume, even if they are buying from someone other than the original seller.

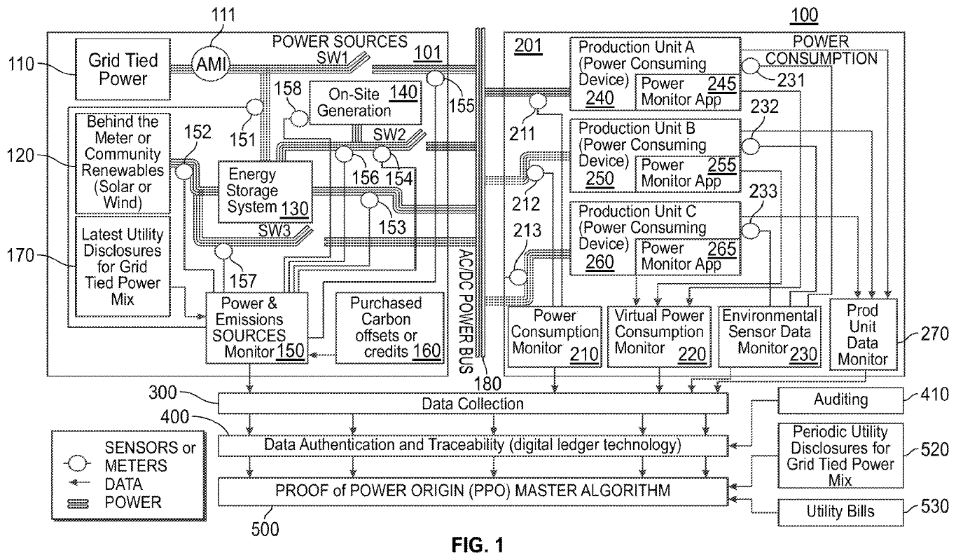

Referring to FIG. 1., a system for determining the verifiable proof of origin for the quantity, source, and emission content of a production environment with an exemplary embodiment is illustrated. System 100 illustrates an exemplary system for measuring sources of power 101 and uses of power 201 in a production environment and applying the accounting methods contained within the Proof of Power Origin (PPO) Master Algorithm 500 to determine if the sources v uses analysis of a production power consuming devices (PCD) or the production environment is out of balance. It is noted that 100 is a simplified view of a production environment that may include other elements that are not depicted.

The power sources 101 depict all the sources of power for the production environment. These may include power that comes from the local utility 110, generated on site from any available fuel type 140, generated by any renewable resource 120, or any of the previously mention sources of power stored in an energy storage system or battery 130. The power from each of these sources may be measured directly by a power meters 111, 158, 152, 153, and may be measured indirectly by a power meter 151, 154, 155, 156, 157, to determine the amount of power from each source that is being utilized if the sources are producing power simultaneously. The amount of power from each source may be determined by taking the measurements from the direct power meters 111, 158, 152, 153, the power measurements from the indirect power meters 151, 154, 155, 156, 157 and the positions of SWI, SW2, and SW3 to determine how much power from each source is being produced and delivered to the power bus bar 180 or to the energy storage system for use later. Power stored in the energy storage system and its carbon content may be tracked by the power & emissions sources monitor. The carbon content of the power later delivered to the power bus 180 from the energy storage system 130 may also be tracked by the power & emissions sources monitor 150. All of the resulting power may be fed to the power bus 180 or stored in the energy storage system 130. The power bus 180 may not be required in the embodiment but may create a clear demarcation between sources and uses.

The system may collect the measurements from each of the power sources 101 within a power & emissions sources monitor 150. The power & emissions sources monitor 150 may also collect all pertinent information regarding any applicable carbon offsets, carbon credits, or other carbon tracking mechanism 160, data describing the fuel or carbon content of purchased power from local utilities or third parties 170.

The power & emissions sources monitor 150 may determine the composition of the total power to the power bus 180, including the carbon content, equivalent carbon content, greenhouse gas emissions, or other metric of environmental impact. All the data regarding the power sources 101 collected and determined by the power & emissions sources monitor 150 may be delivered to the system's data collection layer 300. All this data may have a timestamp. The power consumption 201 may depict all of the uses of power in a production environment and all the mechanisms utilized to directly measure the power consumption (power meters 211, 212, 213 that collect data for the power consumption monitor 210), all the mechanisms utilized to virtually monitor power consumption (power monitor apps 245, 255, 265 that collect data for the virtual power consumption monitor 220), all the mechanisms utilized to infer power consumption through the measurement of environmental factors (environmental sensors 231, 232, 233 that collect data for the environmental sensor data monitor 230), and all the mechanisms to track the production of a production environment (production unit data monitor 270).

All of the data related to the power consumption 201 from the power consumption monitor 210, the virtual power consumption monitor 220, the environmental sensor data monitor 230, and the production unit data monitor 270 may be delivered to the system's data collection layer 300. All this data may have a timestamp.

The data collection layer 300 may have all of the power sources 101 and power consumption 201 related data at this point in the process for any one period of time. Complete data sets may then be copied to the data authentication and traceability layer 400. This layer may reside on a digital ledger that preferably cannot be altered and can be accessed by appropriate parties creating a permanent record of the complete data set related to all production for a given period of time.

The data sets in the data authentication and traceability layer 400 may be processed by a proof of power origin master algorithm 500 which may analyze each power consuming device 240, 250, 260 to determine a correlation between the power monitor app 245, 255, 265, the environment sensors (e.g., heat, clock speed, cycles/s), and production unit data 270. An expectation will be that a production environment production rate will have high correlation between its production rate, its environment, and its consumption of power. By correlating multiple factors, discussed below, to the production environment a confidence level of the actual power consumption may be determined. This multi-factor correlation of data sets derived for independent sources of information, physical measurements from the production environment such as system temperature or production rate, such as manufacturer data that describes the power draw at a particular production rate, operating history such as records of power draw at previous production rates, or data shared from similar facilities or operations such as power draw at known system temperatures or fan speeds, may provide additional levels of confidence for each independent factor that corroborates the measured power consumption. When there is high confidence of the actual consumption of power of the production environment, the power consumption 201 and power sources 101 may be compared, to better assure that no other power has been introduced into the production environment. When confidence is high that no other power has been introduced into the production environment, then the carbon content of the uses of power 101 may be applied to the units of production for the same period of time with the same high confidence level.

The output of the proof of power origin master algorithm 500 may be the correlation rate of data that is inferred from the environmental sensors, declared by the production units, measured by the meters at the production unit, and compared with known consumption rates for production rates and the confidence level developed by the correlation process. The algorithm may develop a higher confidence as more data points are added to this data set for correlation.

### Example Embodiment #1: Injection Mold Plastics Manufacturing

A company makes plastic jars for a pretzel company. The pretzel company may sell the jars full of pretzels, such as to a big box warehouse chain, that may sell them to consumers. The big box company may be publicly traded and may be required by its investors to disclose the carbon content of its products. The present system may enable the big box company to track how much carbon is in each jar, case of jars, shipment etc., further this mechanism may allow the end consumers of the jars to look up how much energy was used to produce the jar that they bought and the related carbon emissions, and amount of recycled material content (if disclosed). This may be accomplished by directly attaching power meters to all sources of power coming into the production facility or being generated onsite, or any energy storage devices. The power sources 101 depict all the sources of power for the production environment. These may include power that comes from the local utility 110, generated on site from any available fuel type 140, generated by any renewable resource 120, or any of the previously mention sources of power stored in an energy storage system or battery 130. The power from each of these sources may be measured directly by a power meters 111, 158, 152, 153, and may be measured indirectly by a power meter 151, 154, 155, 156, 157, to determine the amount of power from each source that is being utilized if the sources are producing power simultaneously. The amount of power from each source may be determined by taking the measurements from the direct power meters 111, 158, 152, 153, the power measurements from the indirect power meters 151, 154, 155, 156, 157 and the positions of SWI, SW2, and SW3 to determine how much power from each source is being produced and delivered to the power bus bar 180 or to the energy storage system for use later. Power stored in the energy storage system and its carbon content may be tracked by the power & emissions sources monitor. The carbon content of the power later delivered to the power bus 180 from the energy storage system 130 may also be tracked by the power & emissions sources monitor 150. All of the resulting power may be fed to the power bus 180 or stored in the energy storage system 130. The power bus 180 may not be required in the embodiment but may create a clear demarcation between sources and uses.

The system may collect the measurements from each of the power sources 101 within a power & emissions sources monitor 150. The power & emissions sources monitor 150 may also collect all pertinent information regarding any applicable carbon offsets, carbon credits, or other carbon tracking mechanism 160, data describing the fuel or carbon content of purchased power from local utilities or third parties 170.

The power & emissions sources monitor 150 may determine the composition of the total power to the power bus 180, including the carbon content, equivalent carbon content, greenhouse gas emissions, or other metric of environmental impact. All the data regarding the power sources 101 collected and determined by the power & emissions sources monitor 150 may be delivered to the system's data collection layer 300, which may be treated as an internal record. All this data may have a timestamp.

Next, directly attach power meters 211, 212, 213, to the power inputs of the production devices (injection mold machines). The data from these meters is aggregated in a power consumption monitor 210. Modern injection mold machinery can also monitor its own internal functions 245, 255, 265. Next, collect all pertinent parameters from an internal monitor in the virtual power consumption monitor. Examples of pertinent parameters include system temperatures, duty cycle, vibration, hydraulic pressures, unit counts, cavity counts, material utilization, ambient air temp. This internal performance and operating data are then collected in the virtual power consumption monitor 220. Meters to account for overhead of the manufacturing environment, including office space, lighting, and other systems that are necessary for the factory but may not be critical to the manufacturing process may not be depicted in FIG. 1.

The following step is an important element to this system in that it may incorporate physical measurements of the environment around the injection molding machine which are not direct measurements of power consumption 231, 232, 233, but individually or in combination may be used to corroborate known performance parameters of the injection mold machine. For example, an injection mold machine of a certain make and model may will have a known operating temperature when running at a particular rate. It may also produce a certain amount of sound, vibration, etc. Collecting data points for the operating temperature of the machine with an external temperature sensor, listening to the noise generated with a microphone, measuring the vibration of the machine as it runs, recording the weight of the tooling, and possibly other physical characteristics may help to corroborate that the measured power consumption is the actual power consumption if these multi-factor characteristics all align with known operating data of such a system per the manufacturer or other credible source of such data. These data sets may all be collected in the environmental sensor data monitor 230.

Corroborating the power consumption may be important as it may enable this system to validate where all the power being consumed is coming from and its carbon content. Knowing this is important as it solves the problem of the plastic jar manufacturer providing energy and carbon content information to consumers about their products that is misleading. Manufacturers of such products may say there is less energy and less carbon in their products in order to gain an advantage in the market okay as such products become more desired by consumers and by big box companies as their reporting and compliance requirements demand that they disclose the carbon in the products that they buy, as described in the Greenhouse Gas Protocol for Scope 3 by the World Resources Institute.

Here is an example of a need for this system to transparently disclose actual emissions:
If a contract manufacturer of plastic jars is running its business on 100% renewable energy from rooftop solar and is producing 1 million plastic jars, and then gets new orders to grows its business to 2 million jars without any more room on its roof to add solar, they might just add a second, night shift and buy more power from the grid to run at night to make the additional jars. The contract buyer for the original 1 million jars may have been told they are using 100% renewables (carbon free energy), when in fact they are now consuming half or so of their energy from the grid with whatever that carbon content is. The new carbon content of the energy consumed to produce the jars may now be something less than 100%. The contract buyer(s) of the jars may be disclosing to their buyers, innocently or otherwise, that they are using carbon free energy to make their jars when, in fact, they are not, and the contract buyer(s) may not have any way to know without auditing the manufacturing plant themselves.

This system solves the current problem that buyers need to have a level of trust as to the carbon content of the goods that they buy. This applies to those that may buy directly from the manufacturer of such goods and those that buy from the original buyer, secondary buyers, and so on. By disclosing the data associated with the ongoing operations of a manufacturing plant, each machine, and each unit of manufacture produced, to an open ledger that can be visible to the stakeholders of a supply chain, the downstream consumers can see that actual carbon content that the manufacturer claims to make up each unit and the confidence it can attribute to that being true by tracking the environmental measurements that corroborate all the power consumption in comparison to all the power sources to assure that no more power was consumed from power sources that were not measured as part of the system (this is where dirty power from the grid would be introduced in an effort to produce more product than the manufacturer had clean power to produce).

The system may also need to understand the actual count of units produced by the manufacturing environment. This may be a physical count of the production performed by an automated system separate from the production units themselves. This data may be collected by the production unit data monitor 270.

All the data related to the power consumption 201 from the power consumption monitor 210, the virtual power consumption monitor 220, the environmental sensor data monitor 230, and the production unit data monitor 270 may be delivered to the system's data collection layer 300. All this data may have a timestamp.

The data collection layer 300 may have all of the power sources 101 and power consumption 201 related data at this point for all the plastic jars manufactured in a given hour from this location. Complete data sets may then be copied to the data authentication and traceability layer 400. This layer may reside on a digital ledger that preferably cannot be altered and can preferably be accessed by appropriate parties, creating a permanent record of the complete data set related to all production for a given period of time.

If the factory has solar on the rooftop, it may be possible that products produced during the day would have less embodied carbon than those produced while the sun was not up. If the factory has solar on the roof and a battery onsite to store solar power then it could produce products with lower carbon content even after the sun went down.

If a jar manufacturer wanted to appear ‘greener’ than they actually are (meaning advertising or labeling their jars as having been made with lower carbon content energy that it actually was), the manufacturer might have added more manufacturing capacity (more machines or a second shift) without adding additional solar to accommodate the additional power needs. In order to demonstrate the carbon content of its jars was lower than it actually is, the manufacturer would either need to assert that it was procuring more clean power or that it was using less power per production unit. This system would make it difficult to impossible to create a high confidence data set that would show less power consumed per production unit (injection mold machine) than it actually was using. A high confidence data set may tell an auditor, or big box company, or consumer that the measured power to an injection mold machine, the computer that comes with the injection mold machine that measures or estimates the power consumed, the manufacturers specifications for the temperature of the system when producing the reported number of units per hour, and the mechanical count of units produced are all highly correlated with known performance history for such machines. For a production facility, this system may scale up to measure not just the confidence levels of the power consumption for each production unit, but for all of them. This may enable all the power sources to be balanced against all the power consumption. If the sources and uses are balanced within an acceptable margin of error, then the carbon content of the sources can be attributed to the injection molding machines for the same period of time and then be attributed further to the plastics jars that were manufactured during the same period.

This data may then be disclosed to the big box company, their auditors, purchasers of the products, or any regulator having jurisdiction, or a customer of a contract manufacturing process who does not have enough trust in the manufacturer to fulfill their carbon emission requirements.

System Audit-In order to better ensure that the system was working effectively, the production plant may undergo periodic audits to determine what information was being disclosed (to the data authenticity and traceability layer 400). Critical information would preferably include the factory location, number of production machines on site, serial numbers of those machines, number of machines operational, number of machines operating, number of cavities per machine. The audit may also cover Amount of waste, Recycled content, Energy per unit.

Each plastic jar could preferably contain a unique identifier that could enable the original buyer or any subsequent buyer, to examine the data that reports the energy, carbon content, etc., for that particular jar or batch of jars. The data may persist on an open ledger accessible by the stakeholders. The jar itself could become a non-fungible token associated with such data for as long as the jar lasts. The data for that plastic jar could be updated upon an end-of-life event for that jar such as recycling or incineration. That data could then be accessible to the upstream stakeholders that made the jar or made the materials that the jar was made from (resin manufacturer).

This embodiment could also incorporate the same information from another instance of this same system deployed upstream in the supply chain. For example, the resin manufacturer could also implement this same system to create a similarly detailed data set describing the carbon and energy content of the resin prior to be made into plastic jars and combining that data set with the data from the manufacture of the plastic jars would create a more complete history and more complete understanding of the total carbon content of the plastic jars. In that case if the jars were recycled, as described above, the resin manufacturer could record the end of life and recycling of a product made from their resin.

### Example Embodiment #2: Crypto Currency Mining Environment

A crypto mining operation may want to minimize its carbon footprint to supply carbon free crypto currency to corporate buyers that want to utilize crypto currency but have carbon disclosure requirements which make them hesitant to use crypto currency if it expands their carbon footprint.

The crypto mining operation may accomplish this by building a solar farm on site 120 and an energy storage system 130 in addition to grid tied power 110 and then directly attaching power meters to all sources of power coming into the crypto mining facility or being generated onsite or any energy storage devices. The power sources 101 depict all the sources of power for the production environment. These may include power that comes from the local utility 110, generated on site from any available fuel type 140, generated by any renewable resource 120, or any of the previously mention sources of power stored in an energy storage system or battery 130. The power from each of these sources may be measured directly by a power meters 111, 158, 152, 153, and may be measured indirectly by a power meter 151, 154, 155, 156, 157, to determine the amount of power from each source that is being utilized if the sources are producing power simultaneously. The amount of power from each source may be determined by taking the measurements from the direct power meters 111, 158, 152, 153, the power measurements from the indirect power meters 151, 154, 155, 156, 157 and the positions of SWI, SW2, and SW3 to determine how much power from each source is being produced and delivered to the power bus bar 180 or to the energy storage system for use later. Power stored in the energy storage system and its carbon content may be tracked by the power & emissions sources monitor. The carbon content of the power later delivered to the power bus 180 from the energy storage system 130 may also be tracked by the power & emissions sources monitor 150. All of the resulting power may be fed to the power bus 180 or stored in the energy storage system 130. The power bus 180 may not be required in the embodiment but may create a clear demarcation between sources and uses.

The system may collect the measurements from each of the power sources 101 within a power & emissions sources monitor 150. The power & emissions sources monitor 150 may also collect all pertinent information regarding any applicable carbon offsets, carbon credits, or other carbon tracking mechanism 160, data describing the fuel or carbon content of purchased power from local utilities or third parties 170.

The power & emissions sources monitor 150 may determine the composition of the total power to the power bus 180, including the carbon content, equivalent carbon content, greenhouse gas emissions, or other metric of environmental impact. All the data regarding the power sources 101 collected and determined by the power & emissions sources monitor 150 may be delivered to the system's data collection layer 300, which may be treated as an internal record. All this data may have a timestamp.

If the crypto mining facility is running entirely on generated and stored solar power, this data set will be able to detail the sources of power into the mining facility as being 100% renewable. The task that remains is to prove up that all the mining rigs being used in the mining facility are running on this 100% renewable power and only on this 100% renewable power, then to create a transparent data trail that can be accessible to buyers of the crypto currency generated in this facility to prove the provenance of the crypto currency and the carbon content of the power that was used to create each token generated at the crypto mining facility.

Next, directly attach power meters 211, 212, 213, to the power inputs of each crypto mining rig. The data from these meters is aggregated in a power consumption monitor 210.

Crypto mining rigs may also monitor their own internal functions 245, 255, 265. Next, collect all pertinent parameters from an internal monitor in the virtual power consumption monitor. Examples of pertinent parameters include make, model, serial number of mining rig, clock speed, complexity of the current task, number of crypto tokens mined or crypto tasks performed, fan speed, CPU temperature, ambient air temp, humidity. This internal performance and operating data is then collected in the virtual power consumption monitor 220.

The external environment may then be measured around each crypto mining rig to measure environmental factors such as temperature, heat generated, air flow, noise, vibration, light generated from mining rig LEDs, air smell, etc. This data may then be correlated with known system specifications from manufactures data, historical data from operating same or similar systems, performance of other systems in the same environment, performance of known systems normalized for seasonal data, altitude, performance by aisle or location in mining facility (top unit in a rack may have different environment that bottom unit), HVAC system operating data in the facility, similar data sets from other similar facilities.

There may be additional meter(s)—not depicted—to account for overhead of the crypto mining facility. This may include office space, lighting, and other systems that are necessary for the larger mining facility but may not be directly apart of the mining process.

All the data related to the power consumption 201 from the power consumption monitor 210, the virtual power consumption monitor 220, the environmental sensor data monitor 230, and the production unit data monitor 270 may be delivered to the system's data collection layer 300. All this data may have a timestamp.

The data collection layer 300 may have all of the power sources 101 and power consumption 201 related data at this point for all the crypto tokens mined and crypto mining tasks performed for each mining rig. Complete data sets may then be copied to the data authentication and traceability layer 400. This layer may reside on a digital ledger that cannot be altered and can be accessed by the appropriate parties creating a permanent record of the complete data set related to all crypto mining for a given period of time.

The data sets for the mining facility and rigs in the data authentication and traceability layer 400 may be processed by the proof of power origin master algorithm 500 which may analyze each power consuming device 240, 250, 260 to determine the correlation between the power monitor app 245, 255, 265, the environment sensors (e.g. heat, clock speed, fan speed, crypto tasks performed, tokens mined), and production unit data 270. The expectation may be that a production environment production rate will have high correlation between its production rate, its environment, and its consumption of power. By applying a multi factor correlation to the mining environment, a confidence level of the actual power consumption can be determined. When there is high confidence of the actual usage of power of the production environment, the power consumption 201 and power sources 101 may be compared to assured that no other power has been introduced into the production environment. When confidence is high that no other power has been introduced into the production environment, then the carbon content of the uses of power 101 may be applied to the units of production for the same period of time with the same high confidence level.

The output of the proof of power origin master algorithm 500 may be the correlation rate of data that is inferred from the environmental sensors, declared by the production units, measured by the meters at the production unit, and compared with known consumption rates for production rates and the confidence level developed by the correlation process. The algorithm may develop a higher confidence as more data points are added to this data set for correlation.

The open ledger used for the data authentication and traceability layer may be linked to the open ledger that may track the crypto currency being generated by the mining rigs operating within the facility. This may create a permanent history link between the crypto currency generated within the crypto mining facility, and the carbon content of the power used to generate the crypto currency. This data and the confidence levels in this data may be used for carbon reporting or disclosure for the original buyers of the generated crypto currency, or any subsequent buyers until the crypto currency has an end-of-life event such as retirement or deregistration.

### Example Embodiment #3: Artificial Intelligence Data Center Environment

A Generative Artificial Intelligence (Gen AI) operation (or future evolutions of Artificial Intelligence) may want to minimize its carbon footprint to supply carbon free Gen AI services to corporate buyers that have carbon disclosure requirements which make them hesitant to expand their carbon footprint and to consumers who are sensitive to the carbon intensity involved with Gen AI solutions and tools.

The Gen AI operation may accomplish this by building a solar farm on site 120 and an energy storage system 130 in addition to grid tied power 110 and then directly attaching power meters to all sources of power coming into the Gen AI data center or being generated onsite or any energy storage devices. The power sources 101 depict all the sources of power for the production environment. These may include power that comes from the local utility 110, generated on site from any available fuel type 140, generated by any renewable resource 120, or any of the previously mention sources of power stored in an energy storage system or battery 130. The power from each of these sources may be measured directly by power meters 111, 158, 152, 153, and may be measured indirectly by power meters 151, 154, 155, 156, 157, to determine the amount of power from each source that is being utilized if the sources are producing power simultaneously. The amount of power from each source may be determined by taking the measurements from the direct power meters 111, 158, 152, 153, the power measurements from the indirect power meters 151, 154, 155, 156, 157 and the positions of SWI, SW2, and SW3 to determine how much power from each source is being produced and delivered to the power bus bar 180 or to the energy storage system for use later. Power stored in the energy storage system and its carbon content may be tracked by the power & emissions sources monitor. The carbon content of the power later delivered to the power bus 180 from the energy storage system 130 may also be tracked by the power & emissions sources monitor 150. All of the resulting power may be fed to the power bus 180 or stored in the energy storage system 130. The power bus 180 may not be required in the embodiment but may create a clear demarcation between sources and uses.

The system may collect the measurements from each of the power sources 101 within a power & emissions sources monitor 150. The power & emissions sources monitor 150 may also collect all pertinent information regarding any applicable carbon offsets, carbon credits, or other carbon tracking mechanism 160, data describing the fuel or carbon content of purchased power from local utilities or third parties 170.

The power & emissions sources monitor 150 may determine the composition of the total power to the power bus 180, including the carbon content, equivalent carbon content, greenhouse gas emissions, or other metric of environmental impact. All the data regarding the power sources 101 collected and determined by the power & emissions sources monitor 150 may be delivered to the system's data collection layer 300, which may be treated as an internal record. All this data may have a timestamp.

If the Gen AI data center is running entirely on generated and stored solar power, this data set will be able to detail the sources of power into the mining or other facility as being 100% renewable. The task that remains is to prove up that all the Graphic Processing Units (GPU) being used in the data center to train Gen AI models or as Gen AI inference servers in the facility are running on this 100% renewable power and only on this 100% renewable power, then to create a transparent data trail that can be accessible to the consumers of Gen AI services generated in this facility to prove the provenance of the Gen AI delivered services and the carbon content of the power that was used to create each generated result at the Gen AI data center facility.

Next, directly attach power meters 211, 212, 213, to the power inputs of each GPU or server rack housing the GPU. The data from these meters is aggregated in a power consumption monitor 210.

GPU servers may also monitor their own internal functions 245, 255, 265. Next, collect all pertinent parameters from an internal monitor in the virtual power consumption monitor. Examples of pertinent parameters include make, model, serial number of each GPU, clock speed, complexity of the current task, number and list of queries performed or training tasks performed, fan speed, CPU temperature, ambient air temp, humidity. This internal performance and operating data is then collected in the virtual power consumption monitor 220.

The external environment may then be measured around each GPU to measure environmental factors such as temperature, heat generated, air flow, noise, vibration, light generated from GPU LEDs, air smell, etc. This data may then be correlated with known system specifications from manufactures data, historical data from operating same or similar systems, performance of other systems in the same environment, performance of known systems normalized for seasonal data, altitude, performance by aisle or location in data center (top unit in a rack may have different environment that bottom unit), HVAC system operating data in the facility, similar data sets from other similar facilities.

There may be additional meter(s)-not depicted-to account for overhead of the Gen AI data center facility. This may include office space, lighting, and other systems that are necessary for the facility but may not be directly a part of the Gen AI process.

All the data related to the power consumption 201 from the power consumption monitor 210, the virtual power consumption monitor 220, the environmental sensor data monitor 230, and the production unit data monitor 270 may be delivered to the system's data collection layer 300. All this data may have a timestamp.

The data collection layer 300 may have all of the power sources 101 and power consumption 201 related data at this point for all the Gen AI model training and inference tasks performed for each GPU. Complete data sets may then be copied to the data authentication and traceability layer 400. This layer may reside on a digital ledger that cannot be altered and can be accessed by the appropriate parties creating a permanent record of the complete data set related to all Gen AI tasks for a given period of time.

The data sets for the data center facility and GPUs in the data authentication and traceability layer 400 may be processed by the proof of power origin master algorithm 500 which may analyze each power consuming device 240, 250, 260 to determine the correlation between the power monitor app 245, 255, 265, the environment sensors (e.g. heat, clock speed, fan speed, crypto tasks performed, tokens mined), and production unit data 270. The expectation may be that a production environment production rate will have high correlation between its production rate, its environment, and its consumption of power. By applying a multi factor correlation to the mining environment, a confidence level of the actual power consumption can be determined. When there is high confidence of the actual usage of power of the production environment, the power consumption 201 and power sources 101 may be compared to assured that no other power has been introduced into the production environment. When confidence is high that no other power has been introduced into the production environment, then the carbon content of the uses of power 101 may be applied to the Gen AI services performed or delivered for the same period of time with the same high confidence level.

The output of the proof of power origin master algorithm 500 may be the correlation rate of data that is inferred from the environmental sensors, declared by the production units, measured by the meters at the production unit, and compared with known consumption rates for production rates and the confidence level developed by the correlation process. The algorithm may develop a higher confidence as more data points are added to this data set for correlation.

The open ledger used for the data authentication and traceability layer may be linked to the open ledger that may track the Gen AI services being performed or delivered by the GPUs operating within the facility. This may create a permanent history link between the Gen AI services performed or delivered from within the Gen AI data center facility, and the carbon content of the power used to generate the services. This data and the confidence levels in this data may be used for carbon reporting or disclosure for the original consumers of the Gen AI deliverables, or any subsequent consumers until an end-of-life event, such as for crypto currency, if there is a secondary consumption possibility. Secondary re-use of the same deliverables may reduce the subsequent carbon intensity of the original delivered services as the carbon intensity may be shared across multiple consumers.

It is to be understood that this disclosure is not intended to limit the invention to any particular embodiments described herein, but to the contrary, the invention is intended to include all modifications, alternatives and equivalents falling within the spirit and scope of the invention.

1. A system for verifiably determining carbon emissions associated with a creation of a unit of production, the system comprising:
a plurality of power sources, each power source of the plurality of power sources having a carbon emission rate per unit of energy and a respective source power meter associated therewith;
a power & emissions source monitor configured to collect, log, and process input power data from the source power meters;
one or more power-consuming device power meters configured to measure a power drawn by one or more power-consuming devices configured to make each unit of production;
a power usage monitor to collect, log and process usage power data from the one or more power-consuming device power meters;
at least one set of measurements to corroborate the uses of power by a mechanism other than directly measuring the power consumption;
a mechanism to determine the emission content of the power sources based on data from the power & emissions sources monitor;
a mechanism to determine the carbon emissions content per unit of production based on the power consumed per unit of production and the emission content of the power produced; and
a mechanism to determine whether there are extraneous sources of power being utilized to produce the units of production by comparing the data from the power sources monitor and the power consumption monitor to detect imbalances between sources of power, the uses of power, and the uses of power corroborated by the at least one set of measurements.

2. The system of claim 1, including at least one device to count the production units as they are produced.

3. The system of claim 2, wherein the data from each of the monitors is recorded in a database.

4. The system of claim 3, wherein a blockchain or other open ledger construct is used as the database.

5. The system of claim 4, wherein at least one measurement used to corroborate the uses of power is derived from a sensor.

6. The system of claim 5, wherein at least one measurement used to corroborate the uses of power is derived from a virtual monitor.

7. The system of claim 6, wherein multiple power sources connect to a common power bus, and the Power Consuming Devices draw power from that common power bus.

8. The system of claim 7, wherein each unit of production is uniquely identified, and the power consumed to produce the unit of production and the composition of the power used to produce the unit of production are stored in the database and associated with the unit of production by its unique identifier.

9. The system of claim 8, wherein the data set required to sufficiently describe the site or facility in which the unit of production was produced, including but not limited to, location, ownership, total amount of power used, total number of Production Units, total number of Production Units running, unique identifiers of Production Units, non-productive overhead power consumption.

10. The system of claim 9, wherein the information required to uniquely identify the unit of production, the power consumed to produce the unit of production, the composition of the power used to produce the product, other elements associated in the data base with the unit of production, are incorporated into a Non-Fungible Token.

11. The system of claim 10, wherein units of production that are not easily serialized are tracked in the database by quantity, to be decremented upon a verified consumption of the unit(s) of production.

12. The system of claim 11, wherein the social good of the unit of production can also be tracked in the database, wherein the social good is a measure of benefit to a community based on the proximity to resources that are consumed to produce a unit of production.

13. The system of claim 12, wherein the units of production, composition of power consumed to produce the units of production, or the rate of producing the units of production are altered based on social good metrics by owners of the Production Units.

14. The system of claim 13, wherein the units of production, composition of power consumed to produce the units of production, or the rate of producing the units of production could be altered based on social good metrics by a local power utility.

15. The system of claim 14, wherein the Production Units are grouped and monitored as a group or like Power Sources are grouped and monitored as a group.

16. The system of claim 15, wherein the unique identifiers of a unit of production are used to track the end of life of an individual unit of production.

17. The system of claim 16, wherein the unique identifiers of a unit of production are used to track how many times the same unit of production is utilized by the same or different consumers.
